(19) United States
(12) Patent Application Publication
(10) Pub. No.: US 2023/0361920 A1
(43) Pub. Date: Nov. 9, 2023

(54) METHOD AND APPARATUS FOR SURVIVAL TIME AND COMMUNICATION SERVICE AVAILABILITY

(71) Applicant: ZTE Corporation, Shenzhen (CN)

(72) Inventors: Jie Tan, Shenzhen (CN); Xiubin Sha, Shenzhen (CN); Bo Dai, Shenzhen (CN); Ting Lu, Shenzhen (CN)

(73) Assignee: ZTE Corporation, Shenzhen (CN)

(21) Appl. No.: 18/352,409

(22) Filed: Jul. 14, 2023

Related U.S. Application Data
(63) Continuation of application No. PCT/CN2021/071840, filed on Jan. 14, 2021.

(51) Int. Cl. H04L 1/08

(52) U.S. Cl. CPC H04L 1/08

(57) ABSTRACT

Preconfiguration parameters, such as survival time and communication service availability target, are part of the application layer. Methods, systems, and devices can wirelessly communicate those parameters on the Radio Access Network (“RAN”) side. A threshold of survival time can be used for triggering Packet Data Convergence Protocol (“PDCP”) duplication. The parameters can be provided by an Access and Mobility Management Function (“AMF”) to a user equipment (“UE”) device by Quality of Service (“QoS”) information or non-access stratum (“NAS”) signalling. The communicated parameters can be used for establishing priorities of logic channels (“LCH”).

### PRIORITY CLAIM

This application claims priority as a Continuation to PCT Application No. PCT/CN2021/071840, filed Jan. 14, 2021, published as WO 2022/151195 A1, entitled “METHOD AND APPARATUS FOR SURVIVAL TIME AND COMMUNICATION SERVICE AVAILABILITY”, the entire disclosure of which is hereby incorporated by reference.

### TECHNICAL FIELD

This document is directed generally to wireless communications. More specifically, a survival time and communication service availability are wirelessly transmitted.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for communicating preconfiguration parameters or information such as those related to survival time and/or a communication service availability target. Those parameters can be wirelessly communicated on the Radio Access Network (“RAN”) side. A threshold of survival time can be used for triggering Packet Data Convergence Protocol (“PDCP”) duplication. The parameters can be provided by an Access and Mobility Management Function (“AMF”) to a user equipment (“UE”) device by Quality of Service (“QoS”) information or non-access stratum (“NAS”) signalling. The communicated parameters can be used for establishing priorities of logic channels (“LCH”).

In one embodiment, a method for wireless communication includes receiving a message including preconfiguration information and a threshold of survival time and activating a duplication function when the threshold of survival time is exceeded. The method further includes providing information for the duplication function activation and providing information for a deactivation of the duplication function. The preconfiguration information comprises at least one of a pre-configured inactive Configured Grant; a pre-configure inactive duplication that precedes the activating of the duplication function; or an indication that a user equipment device can activate the duplication function independently, wherein the pre-configure inactive duplication comprises a number of radio link control (“RLC”) entities. The information provided for the duplication function activation and deactivation further comprises information about the activating of the Configured Grant and the deactivating of the Configured Grant, respectively. When an activation timer is exceeded, the method further comprises receiving a predefined Downlink Communication Information (“DCI”) including an indication to activate the Configured Grant. When the number of RLC entities is greater than one, the information for the duplication function activation further comprises an identification of each of the RLC entities and an indication of a state of activation or deactivation. The principle selection of the RLC entities comprises at least one of an index number of logical channels; measurement results of logical channels; or a list of logical channels. The information provided for the duplication function activation and deactivation comprises at least one of an Uplink Control Information (“UCI”); a MAC Control Element (“MAC CE”); or a buffer status report (“BSR”). The message comprises a radio resource control “RRC” message, which includes at least one of RRCReestablishment, RRCReconfiguration, RRCResume, RRCReject, or RRCSetup.

In another embodiment, a method for wireless communication includes receiving a message including preconfiguration information and a threshold of survival time and when the threshold of survival time is not exceeded and a survival time timer is reset, sending a request containing a deactivate the Configured Grant information, wherein the request comprises an Uplink Control Information (“UCI”) or a MAC Control Element (“MAC CE”).

In another embodiment, a method for wireless communication includes providing a message including preconfiguration information and a threshold of survival time. The preconfiguration information comprises at least one of a pre-configured inactive Configured Grant, a pre-configured inactive duplication that precedes an activating of the duplication function, or an indication that a user equipment device can activate the duplication function or PDCP replication independently. The pre-configured inactive duplication comprises a number of radio link control (“RLC”) entities. The method further comprising triggering activation of a duplication function when the threshold of survival time is exceeded. The method includes implementing an activation timer for a determination of whether the threshold of survival time is exceeded before data is received, wherein a duplication function is activated when the threshold is exceeded. The method includes receiving an indication that the duplication function has been activated and activating a deactivation timer for deactivating the duplication function. The preconfiguration parameters comprise a pre-configured inactive Configured Grant, and the method further comprises activating the Configured Grant by providing a predefined downlink control information (“DCI”) to a user equipment device. The preconfiguration information comprises at least one of a pre-configured inactive Configured Grant; a pre-configure inactive duplication that precedes the activating of the duplication function; or an indication that a user equipment device can activate the PDCP replication function independently, wherein the pre-configure inactive duplication comprises a number of radio link control (“RLC”) entities. When the number of RLC entities is greater than one, the information of the duplication function activation further comprises an identification of each of the RLC entities and an indication of a state of activation or deactivation. The method for the UE to select RLC entities comprises at least one of an index number of logical channels, measurement results of logical channels, or a list of logical channels. When the threshold of survival time is not exceeded and a survival time timer is reset, the method further comprises receiving a request to deactivate the Configured Grant, wherein the request information comprises an Uplink Control Information (“UCI”) or a MAC Control Element (“MAC CE”).

In another embodiment, a method for wireless communication includes providing a message with a plurality of logic channel priorities, measuring, with a survival timer, a threshold for a communication services availability target, and indicating, when the threshold is exceeded, that at least one of the logic channel priorities switches to a higher priority. The method further comprises indicating, when the threshold is not exceeded after switching to the higher priority logical channel, that the at least one of the logic channels switches to a lower priority. The method further comprises receiving, Quality of Service (QoS) information from Access and Mobility Management Function (“AMF”), wherein QoS information comprises a parameter related to the communication services availability target. The parameter comprises at least one of a value of the communication services availability target; a level value of the communication services availability target; an index related to the communication service availability target; or a number of survival time triggers allowed in a period of time. The plurality of the logic channel priorities comprises a plurality of logic channels with different priorities or one logic channel comprising multiple different priorities. The message comprises a radio resource control “RRC” message, which includes at least one of RRCReestablishment, RRCReconfiguration, RRCResume, RRCReject, or RRCSetup. The indicating further comprises a Downlink Control Information (“DCI”) or a MAC Control Element (“MAC CE”) indication provided to a user equipment device.

In another embodiment, a method for wireless communication includes receiving Quality of Service (QoS) information from Access and Mobility Management Function (“AMF”), wherein the QoS information comprises a parameter related to the communication services availability target, and the parameter comprises at least one of a value of the communication services availability target, a level value of the communication services availability target, an index related to the communication service availability target; the value of survival time, or a number of survival time triggers allowed in a period of time. The method further comprises providing a message with a plurality of logic channel priorities. The method further comprises measuring, with a survival timer, a threshold for a communication services availability target. The method further comprises indicating, when the threshold is exceeded, that at least one of the logic channel priorities switches to a higher priority The method further comprises indicating, when the threshold is not exceeded after switching to the higher priority logical channel, that the at least one of the logic channels switches to a lower priority. The plurality of the logic channel priorities comprises a plurality of logic channels with different priorities or one logic channel comprising multiple different priorities. The message comprises a radio resource control “RRC” message, which includes at least one of RRCReestablishment, RRCReconfiguration, RRCResume, RRCReject, or RRCSetup. The indicating further is included in a Downlink Control Information (“DCI”) or a MAC Control Element (“MAC CE”) indication provided to a user equipment device. The value of survival time comprises at least one of a value range of survival time in microseconds, a value range of survival time in 500 nanoseconds, or a value range of survival time in terms of services cycle

In another embodiment, a method for wireless communication includes receiving a message with a plurality of logic channel priorities, measuring, with a survival timer, a threshold for a communication services availability target, and requesting, when the threshold is exceeded, that at least one of the logic channel priorities switches to a higher priority. The method further comprises receiving, non-access stratum (“NAS”) signalling from Access and Mobility Management Function (“AMF”), wherein NAS signalling comprises at least one of a value of survival time, or a parameter related to the communication services availability target. The method further comprises requesting, when the threshold is not exceeded after switching to the higher priority, that the at least one of the logic channels switches to a lower priority. The value of survival time comprises at least one of a value range of survival time in microseconds; a value range of survival time in 500 nanoseconds, or a value range of survival time in terms of services cycle. The parameter related to the communication services availability target comprises at least one of a value of the communication services availability target; a level value of the communication services availability target; an index related to the communication service availability target; or a number of survival time triggers allowed in a period of time . . . . The plurality of the logic channel priorities comprises a plurality of logic channels with different priorities or one logic channel comprising multiple different priorities. The requesting comprises at least one of an Uplink Control Information (“UCI”); or a MAC Control Element (“MAC CE”).

In another embodiment, a system for wireless communication includes an Access and Mobility Management Function (“AMF”) that provides a parameter related to the communication services availability to a basestation by Quality of Service (“QoS”) information. The parameter comprises at least one of a value of the communication services availability target; a level value of the communication services availability target; an index related to the communication service availability target; or a number of survival time triggers allowed in a period of time. The Quality of Service (QoS) information comprises downlink information or uplink information.

In another embodiment, a system for wireless communication includes an Access and Mobility Management Function (“AMF”) that provides a survival time and a parameter related to the communication services availability to a user equipment device by non-access stratum (“NAS”) signalling. The parameter comprises at least one of a value of the communication services availability target; a level value of the communication services availability target; an index related to the communication service availability target; or a number of survival time triggers allowed in a period of time. The value of survival time comprises at least one of a value range of survival time in nanoseconds; a value range of survival time in 500 nanoseconds; or a value range of survival time in terms of services cycle.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows one embodiment of duplication using preconfiguration parameters.

FIG. 4 shows another embodiment of duplication using preconfiguration parameters.

FIG. 5 shows another embodiment of duplication when a threshold of survival is not exceeded.

FIG. 6 shows one embodiment of preconfiguration parameter transmission.

FIG. 7 shows another embodiment of preconfiguration parameter transmission with basestation measurement of trigger times.

FIG. 8 shows another embodiment of preconfiguration parameter transmission with user equipment device measurement of trigger times.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

New Radio Access (“NR”) includes the parameter survival time in the application layer to relax the quality of service (“QoS”) requirements for reliability. The survival time may be transferred as part of the TSC Assistance Information (“TSCAI”) parameter. The TSCAI may not always include the survival time. The Session Management Function (“SMF”) determines survival time and sends it to the Next Generation Radio Access Network (“NG RAN”) as part of TSCAI without requiring a specific signalling exchange with the user equipment (“UE”) device. The RAN may be a part of a wireless communication system that connects UE devices to other parts of a network through radio or wireless connections.

The survival time may include the time that an application consuming a communication service may continue without an anticipated message. The survival time information may further include the maximum number of consecutive message transmission failures. The SMF translates the maximum number of consecutive message transmission failures to a time unit based on a TSCAI periodicity parameter and determines survival time.

Different services can have very different communication service availability targets even though they have similar or equivalent survival times. The communication servicer availability parameter may indicate if the communication system is functioning properly (e.g. “available”/“unavailable” state). The communication system may be in the “available” state as long as the availability criteria for transmitted packets are met. The service may be unavailable if the packets received at the target are improper or late. The availability of the communication service may be calculated using the down time interval as experienced by the application. Therefore, achieving different communication service availability targets requires different configurations for radio functions. This requires the RAN to be aware of the communication service availability target for a flow.

The communication service availability may include a percentage value of the amount of time the end-to-end communication service is delivered according to an agreed QoS that is then divided by the amount of time the system is expected to deliver the end-to-end service according to the specification in a specific area. The availability of the communication service may be calculated using the accumulated down time. In one embodiment, when the communication service is expected to run for a time T, the unavailability U of the communication service can be calculated as:

$$U = \frac{{\sum }_{i} Δ {t}_{i}}{T}$$

where Δtᵢ is the length of the i-th downtime interval of the communication service within the time period T. The communication service availability A can then be calculated as A=1−U.

As described below, the survival time and or parameters related to communication service availability may be referred to as preconfiguration information or parameters. Specifically, the parameters may be pre-configured and the methods, systems, and devices described communicate those parameters wirelessly communicated on the Radio Access Network (“RAN”) side. A threshold of survival time can be used for triggering Packet Data Convergence Protocol (“PDCP”) duplication. The parameters can be provided by an Access and Mobility Management Function (“AMF”) to a user equipment (“UE”) device by Quality of Service (“QoS”) information or non-access stratum (“NAS”) signalling. The communicated parameters can be used for establishing priorities of logic channels (“LCH”).

Radio resource control (“RRC”) is a protocol layer between UE and the basestation at the IP level (Network Layer). RRC messages are transported via the Packet Data Convergence Protocol (“PDCP”). As described, UE can transmit infrequent (periodic and/or non-periodic) data in RRC_INACTIVE state without moving to an RRC_CONECTED state. This can save the UE power consumption and signaling overhead. This can be through a Random Access Channel (“RACH”) protocol scheme or a Configured Grant (“CG”) scheme. Although the CG scheme is further described below, it is merely one example of a protocol scheme for communications and other examples, including but not limited to RACH, are possible.

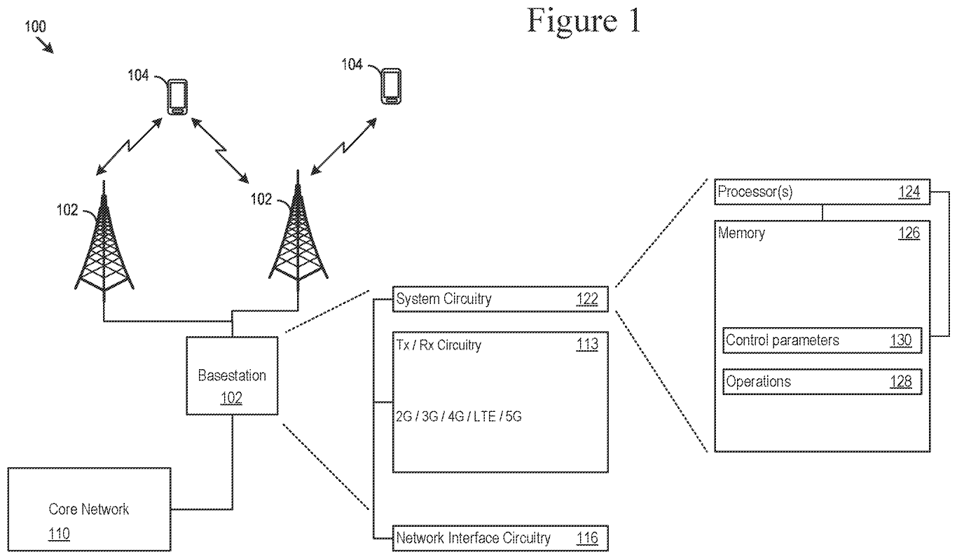

FIG. 1 shows an example basestation 102. The basestation may also be referred to as a wireless network node. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

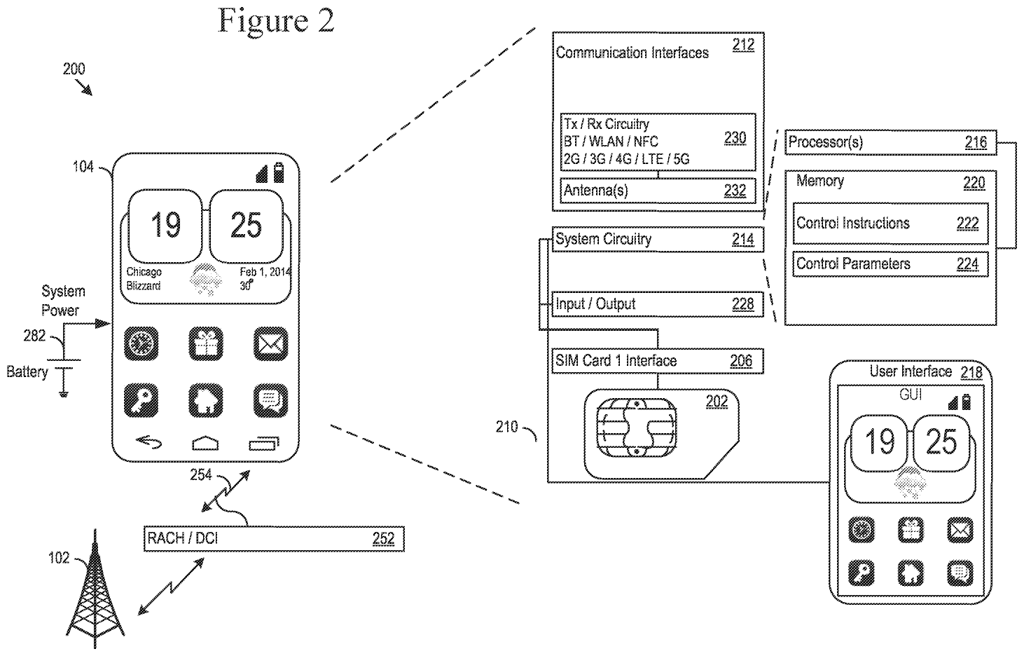

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

A duplication function may include packet duplication that ensures that packets are not missed and reliability is improved. Packet Data Convergence Protocol (“PDCP”) duplication is one example of a duplication function. The PDCP layer handles transfer of user data, header compression, sequence numbering, duplication detection, packet duplication, etc. PDCP duplication may be supported for both user and control planes. The PDCP layer in the transmitter may be responsible for packet duplication while the PDCP layer in the receiver can detect duplicate packets. Duplicated packets have the same PDCP sequence number, which can be used for identification.

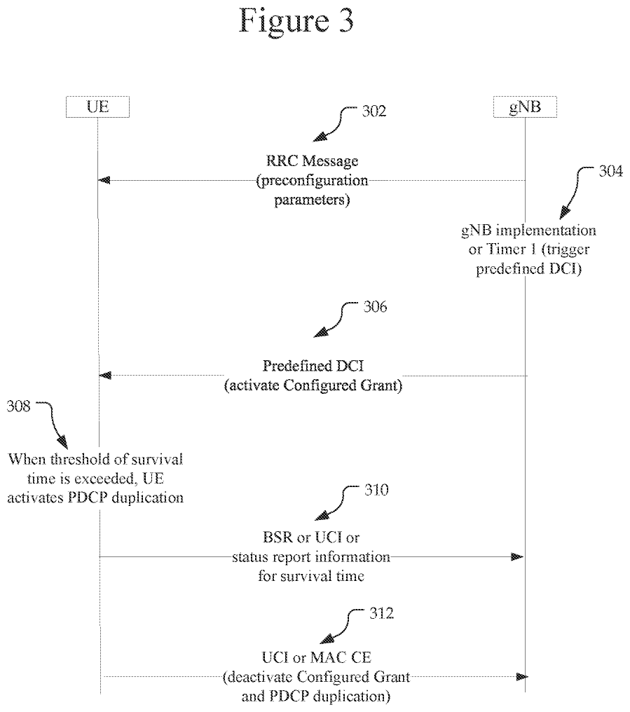

FIG. 3 shows one embodiment of duplication using preconfiguration parameters. For FIG. 3, the UE independently activates PDCP duplication. In the uplink packet transmission, the UE can trigger the UE to activate the PDCP duplication autonomously based on measurement results. In block 302, the gNB (i.e. basestation) configures preconfiguration parameters in an RRC message. The RRC message 302 may include at least one of the following: RRCReestablishment, RRCReconfiguration, RRCResume, RRCReject, RRCSetup.

The preconfiguration parameters in message 302 may also be referred to as preconfiguration information and may include but is not limited to survival time and/or communication service availability parameters. In the example of FIG. 3, the preconfiguration parameters may include pre-configure inactive PDCP duplication, pre-configure inactive Configured Grant, configure the threshold of survival time, and/or an indication that that UE can activate PDCP duplication independently. The pre-configure inactive PDCP duplication and pre-configure inactive CG may be examples of preconfiguration parameters. PDCP duplication is a function while CG is a kind of uplink resources. Before PDCP duplication can be activated for use, the CG should be prepared. For example, CG should not only be pre-configured but also be activated when (or before) PDCP duplication.

In block 304, the gNB uses an activation timer 1 or a gNB implementation to trigger a predefined downlink control information (“DCI”) to indicate the activation of the Configured Grant (“CG”). CG may be used to reduce the waste of periodically allocated resources by enabling multiple devices to share periodic resources. The basestation may assign CG resources to eliminate packet transmission delay and to increase a utilization ratio of allocated periodic radio resources.

When the service is periodic, the activation timer 1 starts when no packet is received on the period in which the packet should be received. The value of the timer may be set as less than the threshold of survival time. Before the timer expires, the timer is reset if the packet is received. Otherwise, the predefined DCI in block 306 is triggered to activate the CG after the timer expires.

Alternatively, when the service is aperiodic, the timer is started after each packet is received. The value of the timer may be set as less than the threshold of survival time. Before the timer expires, the timer is reset if the packet is received. Otherwise, the predefined DCI in block 306 is triggered to activate the CG after the timer expires.

When the threshold of survival time is exceeded in block 308, the UE independently activates the duplication function (e.g. PDCP duplication). The copied packet can be sent through the activated CG and the Buffer Status Report (“BSR”) or the status report information of survival time may include an indication of the status of the UE activating the PDCP duplication in block 310. BSR may use the reserved LCID in UL-SCH to indicate UE to activate PDCP duplication.

However, the indication may change based on the number of RLC entities in the pre-configure inactive PDCP duplication. There may be two different cases. The first case is when the number of RLC entities is 1, and the second case is when the number of RLC entities is greater than 1. Case 1 does not need to indicate to the gNB before sending the copied data packet, and case 2 may or may not need to send the indication information. For case 2, the method for sending indication information may include at least one of the following: using BSR with indication information, using predefined uplink control information (“UCI”) to include indication information, and/or using the status report information of survival time to include indication information. The indication information may include at least one of the following: an indication of the identification i (e.g. i=1,2,3) of the RLC entity and an indication that the RLC entity i is in the state of activation or deactivation, where i is the ascending order of the logical channel identification of the RLC entity. The method for UE to select RLC entities comprises at least one of: 1) index number of logical channels (“LCH”); 2) measurement results of logical channels; or 3) a list of logical channels.

In block 312, the UE can autonomously deactivate PDCP duplication and/or CG. The UE deactivation of PDCP duplication includes at least one of the following: 1) the predefined UCI contains deactivation indication information; or 2) a predefined MAC Control Element (“MAC CE”) format containing deactivation indication information is indicated by the LCID reserved in the UL-SCH.

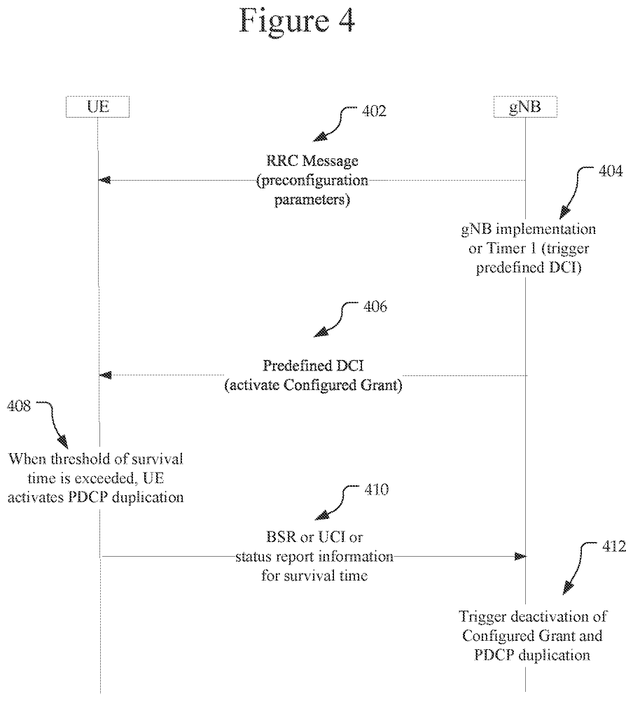

FIG. 4 shows another embodiment of duplication using preconfiguration parameters. In block 402, the gNB (i.e. basestation) configures preconfiguration parameters in an RRC message. The RRC message 402 may include at least one of the following: RRCReestablishment, RRCReconfiguration, RRCResume, RRCReject, RRCSetup. The preconfiguration parameters in message 402 may also be referred to as preconfiguration information and may include but is not limited to survival time and/or communication service availability parameters. The preconfiguration parameters may include pre-configure inactive PDCP duplication, pre-configure inactive Configured Grant, configure the threshold of survival time, and/or an indication that that UE can activate PDCP duplication independently. The pre-configure inactive PDCP duplication and pre-configure inactive CG may be examples of preconfiguration parameters. PDCP duplication is a function while CG is a kind of uplink resources. Before PDCP duplication can be activated for use, the CG should be prepared. For example, CG should not only be pre-configured but also be activated when (or before) PDCP duplication.

In block 404, the gNB uses an activation timer 1 or a gNB implementation to trigger a predefined downlink control information (“DCI”) to indicate the activation of the Configured Grant (“CG”). CG may be used to reduce the waste of periodically allocated resources by enabling multiple devices to share periodic resources. The basestation may assign CG resources to eliminate packet transmission delay and to increase a utilization ratio of allocated periodic radio resources.

When the service is periodic, the activation timer 1 starts when no packet is received on the period in which the packet should be received. The value of the timer may be set as less than the threshold of survival time. Before the timer expires, the timer is reset if the packet is received. Otherwise, the predefined DCI in block 406 is triggered to activate the CG after the timer expires. Alternatively, when the service is aperiodic, the timer is started after each packet is received. The value of the timer may be set as less than the threshold of survival time. Before the timer expires, the timer is reset if the packet is received. Otherwise, the predefined DCI in block 406 is triggered to activate the CG after the timer expires.

When the threshold of survival time is exceeded in block 408, the UE independently activates the duplication function (e.g. PDCP duplication). The copied packet can be sent through the activated CG and the Buffer Status Report (“BSR”) or the status report information of survival time may include an indication of the status of the UE activating the PDCP duplication in block 410. BSR may use the reserved LCID in UL-SCH to indicate UE to activate PDCP duplication. The indication may change based on the number of RLC entities in the pre-configure inactive PDCP duplication. There may be two different cases as discussed with respect to FIG. 3. The first case is when the number of RLC entities is 1, and the second case is when the number of RLC entities is greater than 1. Case 1 does not need to indicate to the gNB before sending the copied data packet, and case 2 may or may not need to send the indication information.

When gNB receives a packet correctly, the survival time timer does not expire. The difference between FIG. 3 and FIG. 4 is PDCP duplication deactivation and CG deactivation. In block 412, gNB implementation or deactivation timer 2 is used to trigger deactivation of CG and PDCP duplication. The deactivation timer is set in gNB. The timer starts when the packet is received, with the value of the timer being greater than the threshold of the survival time. The timer is reset if a packet is received before the timer expires.

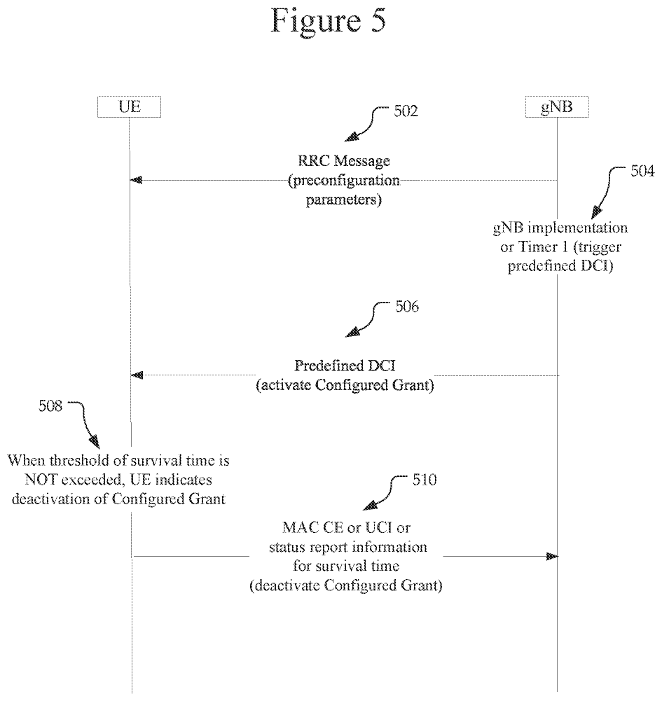

FIG. 5 shows another embodiment of duplication when a threshold of survival is not exceeded. In block 502, the gNB (i.e. basestation) configures preconfiguration parameters in an RRC message. The RRC message 502 may include at least one of the following: RRCReestablishment, RRCReconfiguration, RRCResume, RRCReject, RRCSetup. The preconfiguration parameters in message 502 may also be referred to as preconfiguration information and may include but is not limited to survival time and/or communication service availability parameters. The preconfiguration parameters may include pre-configure inactive PDCP duplication, pre-configure inactive Configured Grant, configure the threshold of survival time, and/or an indication that that UE can activate PDCP duplication independently. The pre-configure inactive PDCP duplication and pre-configure inactive CG may be examples of preconfiguration parameters. PDCP duplication is a function while CG is a kind of uplink resources. Before PDCP duplication can be activated for use, the CG should be prepared. For example, CG should not only be pre-configured but also be activated when (or before) PDCP duplication.

In block 504, the gNB uses an activation timer 1 or a gNB implementation to trigger a predefined downlink control information (“DCI”) to indicate the activation of the Configured Grant (“CG”). CG may be used to reduce the waste of periodically allocated resources by enabling multiple devices to share periodic resources. The basestation may assign CG resources to eliminate packet transmission delay and to increase a utilization ratio of allocated periodic radio resources.

When the service is periodic, the activation timer 1 starts when no packet is received on the period in which the packet should be received. The value of the timer may be set as less than the threshold of survival time. Before the timer expires, the timer is reset if the packet is received. Otherwise, the predefined DCI in block 506 is triggered to activate the CG after the timer expires. Alternatively, when the service is aperiodic, the timer is started after each packet is received. The value of the timer may be set as less than the threshold of survival time. Before the timer expires, the timer is reset if the packet is received. Otherwise, the predefined DCI in block 506 is triggered to activate the CG after the timer expires.

The difference in FIG. 5 as compared to FIGS. 3-4 is in block 508, where the threshold of survival time is not exceeded. When the threshold of the survival time is not exceeded in block 508, CG inactivation includes at least one of the following: the predefined UCI includes the above indication information, the predefined MAC CE format includes the indication information and is indicated by the LCID reserved in the ULSCH, and/or the indication information is included in the status report information of the survival time as in block 510.

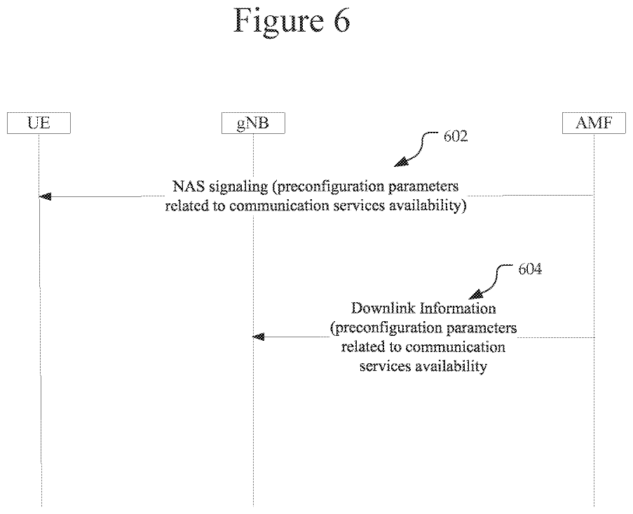

FIG. 6 shows one embodiment of preconfiguration parameter transmission. In uplink and downlink packet transmission, Access and Mobility Management Function (“AMF”) sends survival time and/or preconfiguration parameters related to the communication services availability targets to gNB and/or UE. The AMF may be an entity that utilizes the Next Generation Application Protocol (“NGAP”) to carry Non Access Stratum (“NAS”) messages. The AMF receives these requests and manages connections.

The AMF uses the non-access stratum NAS signalling to send preconfiguration parameters such as the survival time and/or parameters related to the communication services availability target to UE in block 602. The signal may include a packet data unit (“PDU”) that may include the following: PDU SESSION RESOURCE SETUP REQUEST, PDU SESSION RESOURCE RELEASE COMMAND, PDU SESSION RESOURCE MODIFY REQUEST, INITIAL CONTEXT SETUP REQUEST, HANDOVER REQUEST, INITIAL UE MESSAGE, DOWNLINK NAS TRANSPORT.

AMF may utilize downlink control information (“DCI”) to send parameters related to the communication services availability target to gNB via a next generation interface in block 604. The downlink information may include at least one of the following: PDU SESSION RESOURCE SETUP REQUEST message, PDU SESSION RESOURCE RELEASE COMMAND message, PDU SESSION RESOURCE MODIFY REQUEST message, PDU SESSION RESOURCE NOTIFY message, PDU SESSION RESOURCE MODIFY INDICATION message.

The parameters related to the communication services availability target may include at least one of the following: a value of the communication services availability, a level value of the communication services availability, an index related to the availability of the communication service, and/or a number of survival time triggers allowed in a period of time. The unit and value range of the parameter survival time include at least one of the following: a value range of survival time in microseconds is (e.g. 0 . . . 180000000, . . . ) or (e.g. 0 . . . 1920000, . . . ), a value range of survival time in 500 nanoseconds (e.g. 0 . . . 360000000, . . . ), and a value range of survival time in terms of services cycle is (e.g. 1 . . . 3, . . . ).

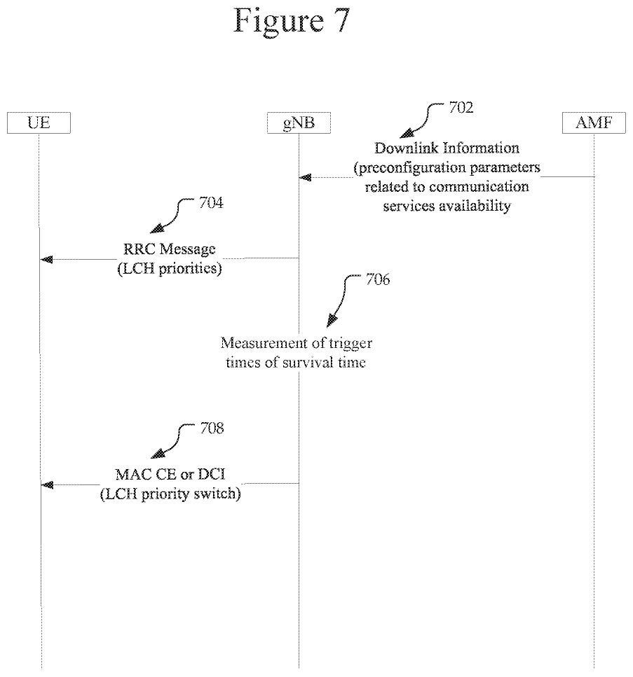

FIG. 7 shows another embodiment of preconfiguration parameter transmission with basestation measurement of trigger times. In uplink and downlink packet transmission, the gNB performs relevant measurements, and the gNB indicates to the UE to transmit packets on different priorities of the logic channel (“LCH”) according to the measurement results.

The AMF uses downlink information in block 702 to send preconfiguration parameters to the basestation gNB. The basestation gNB configures the UE with different LCH priorities in an RRC message in block 704. The RRC may include at least one of the following: RRCReestablishment, RRCReconfiguration, RRCResume, RRCReject, or RRCSetup. The different LCH priorities may be two LCH with different priorities or one LCH with multiple different priorities. In one embodiment, the UE may initially send uplink packets on low priority LCH.

The gNB determines whether the priority of the LCH needs to be switched based on the trigger of the survival time or the number of times the survival time is allowed to trigger over a period of time in block 706. This measurement may include starting timer 1 after each survival time timer trigger, where the value of the timer 1 is related to the survival time timer. If the trigger number of the survival time in the timer 1 is less than the allowable trigger number of the high-level configuration, then timer 1 is reset.

Conversely, when the timer 1 is reset, and the LCH handover process or the cell handover process is triggered. After the LCH handover process is triggered, the gNB indicates to the UE to switch to the high-priority LCH to send uplink data in block 708. The gNB indication includes at least one of the following: the handover of LCH is activated by MAC CE including indication information, and/or the handover of LCH is activated by DCI including indication information on the Physical Downlink Control Channel (“PDCCH”).

After the LCH is triggered to perform the handover process based on the survival time timer, if the survival time timer does not expire, the gNB indicates to the UE to switch to the low priority LCH to send uplink data. After the LCH is triggered to perform the handover process based on the timer 1, if the timer 1 expires, the gNB may indicate to the UE to switch to the low priority LCH to send uplink data. The gNB indication includes at least one of the following: the handover of LCH is activated by MAC CE including indication information, and/or the handover of LCH is activated by DCI including indication information on the PDCCH.

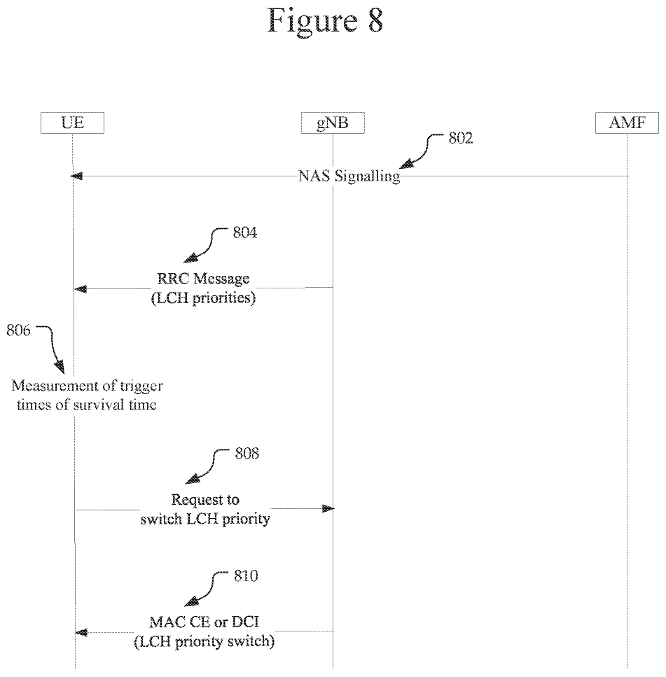

FIG. 8 shows another embodiment of preconfiguration parameter transmission with user equipment (“UE”) device measurement of trigger times. In uplink and downlink packet transmission, the UE performs relevant measurements, and the UE requests to the gNB to transmit packets on different priorities of the logic channel (“LCH”) according to the measurement results.

The AMF uses the NAS-PDU in NAS signaling to send the preconfiguration parameters to UE in block 802. Before the measurement of survival time, the gNB configures two LCHs with different priority for UE through an RRC message in block 804. The RRC message includes at least one of the following: RRCReestablishment, RRCReconfiguration, RRCResume, RRCReject, or RRCSetup. The UE may initially send uplink packets on LCH with low priority selected.

The UE determines whether the priority of the LCH needs to be switched based on a measurement in block 806. The measurement includes the trigger of the survival time or the number of times the survival time is allowed to trigger over a period of time. This may include starting timer 1 after each survival time timer trigger, where the value of the timer 1 is related to the survival time timer. If the trigger number of the survival time in timer 1 is less than the allowable trigger number of the high-level configuration, then timer 1 is reset. Conversely, the timer 1 is reset, when the LCH handover process or the cell handover process is triggered.

The UE can trigger the gNB with a request to switch priority of LCH in block 808. The request to the gNB may be to perform the LCH handover process may include survival time timer triggers LCH to switch to high priority. After the LCH is triggered to perform the handover process based on the survival time timer, if the triggered survival time timer does not expire, the LCH may be triggered to switch to a low priority. In another embodiment, the LCH may be triggered to switch to high priority based on timer 1. After triggering LCH to switch to high priority based on timer 1, if the timer expires, there may be a trigger for LCH to switch to low priority. The request information includes at least one of the following: the status reporting information of the survival time, a MAC CE including the request indication handover information, and/or a UCI including the request indication handover information. Upon receipt of the request message. The gNB indicates that the activation LCH handover includes at least one of the following: activating LCH handover through MAC CE including indication information, and/or activating LCH handover through DCI containing indication information on PDCCH as in block 810.

The UE itself can trigger the switch of priority of LCH by either survival time timer or timer 1. When the trigger number of the survival time in timer 1 is less than the allowable trigger number of the high-level configuration, the UE itself triggers LCH to switch to higher priority. After the LCH is triggered to perform the handover process based on timer 1, if the timer expires, there may be a trigger for LCH to switch to lower priority by the UE itself. The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication, comprising:
receiving a message including preconfiguration information and a threshold of survival time; and
activating a duplication function when the threshold of survival time is exceeded.
